(19) United States
(12) Patent Application Publication
(10) Pub. No.: US 2008/0223982 A1
(43) Pub. Date: Sep. 18, 2008

(54) Method and device for wind generated electricity

(76) Inventors: Gal Pri-Paz, Netanya (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/716,970

(22) Filed: Mar. 13, 2007

(51) Int. Cl. B64B 1/50

(52) U.S. Cl. 244/33; 290/55

(57) ABSTRACT

An airborne electricity producing generator powered by wind at high altitude. A gas filled balloon keeps the turbines and other apparatus afloat. Connection with the ground is with tethers that also prevent the apparatus from floating freely and conduct electricity, thereby bringing the electricity produced to ground based transformers. Computer controls the position, direction, tilt and height of the apparatus depending on wind direction and speed.

### FIELD OF THE INVENTION

This invention is in the field of electricity generation and more particularly the generation of electricity using wind power at high altitudes.

### BACKGROUND OF THE INVENTION

Electricity is generated by different methods. Electricity has been generated for the purpose of powering human technologies for over a hundred years from various sources of potential energy. The first power plants were run on wood, while today we rely mainly on petroleum, natural gas, coal, hydroelectric and nuclear power. On a smaller scale electricity is generated from hydrogen, solar energy, tidal harnesses, wind generators, and geothermal sources.

The demand for electricity can be met in two different ways. The primary method thus far has been for public or private utilities to construct large scale centralized projects to generate and transmit the electricity. Many of these projects have caused unpleasant environmental effects such as air or radiation pollution or the flooding of large areas of land.

Rotating turbines attached to electrical generators produce most commercially available electricity. Turbines may be driven by using steam, water, wind or other fluids as an intermediate energy carrier. The most common usage is by steam in fossil fuel power plants or nuclear power plants, and by water in hydroelectric dams. Alternately, turbines can be driven directly by the combustion of natural gas or oil. Combined cycle gas turbine plants offer efficiencies of up to 60%. They generate power by burning natural gas in a gas turbine and use residual heat to generate additional electricity from steam. Solar parabolic troughs and solar power towers concentrate sunlight to heat a heat transfer fluid that is used to produce steam to turn a turbine. Small electricity generators are often powered by reciprocating engines burning diesel, biogas or natural gas. Diesel engines are often used for back up generation, usually at low voltages. Biogas is often combusted where it is produced, such as a landfill or wastewater treatment plant, with a reciprocating engine or a micro-turbine.

Solar updraft towers use wind that is artificially produced inside the chimney by heating it with sunlight.

Using fossil fuel has many drawbacks. Amongst these are harmful emissions, smoke and other toxic wastes. In addition, a greenhouse effect is produced by damaging the natural protection of the earth's atmosphere from solar and other radiation. Additionally, fuel is a limited resource, once used can not easily be replaced. Another disadvantage of using fossil fuels, that it is sometimes used as a political tool as a means of blackmailing the buyer and user of the fuel to conform to the political wishes of the fuel supplier.

By contrast, wind turbines generate electricity by using the power of wind to turn the turbine. Wind energy is a pollution-free, infinitely sustainable form of energy. It does not have the disadvantages of fossil fuel. It does not produce gases affecting the atmosphere and it does not produce toxic or radioactive waste.

For any wind turbine, the power and energy produced changes dramatically as the wind speed changes. This is expressed in a formula which says wind power is proportional to its velocity cubed. Therefore, the most cost-effective wind powered turbines are located in the areas with the highest average annual wind speeds. Wind speed is affected by the local terrain and usually increases with height above the ground, so wind turbines are usually mounted on tall structures on high terrain. However, the height of such structures is limited.

Airborne electricity generating farms are relatively cheap to construct compared with more conventional power plants. The cost of producing wind powered electricity has dropped in recent years. The cost of producing each kilowatt hour of electricity is now five cents or less. Furthermore, each megawatt-hour of electricity that is generated by wind energy helps to reduce by about one ton “greenhouse gas emissions” that are produced by coal or diesel fuel generation each year. The emission of solid particle waste produced by a medium sized coal fired power plant can be in the region of 250 tones a day.

An additional advantage to such generating systems could be the possibility of mounting additional generating turbines on the tethers anchoring these airborne systems to the ground, thus increasing output without proportionately increasing costs.

An additional advantage is the possibility of being able to mount communication, broadcasting and other types of antennas on these devices. Since the antennas are situated high above the ground they would transmit over a wide area, and thus, obviate the need for the construction of low-level, unsightly towers and increase transmission quality.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

The invention is a lighter-than-air gas filled balloon, like for example Hydrogen or Helium, which is moored to trolleys by tethers. These trolleys could travel on tracks on the ground and the tethers could be attached to electrically powered motorized winches mounted on the trolleys. The rotation of the winches will cause the tethers to wind in or out, depending on the direction of rotation. This action will cause the gas balloon to be raised or lowered. The trolleys, when mounted on tracks, enable them to move within specified confines.

The tracks could be circular, thus enabling the gas balloon to be constantly facing the wind. There could be direction sensors connected to a computer with a program to keep the balloon facing the optimal direction to best catch the force of the wind. The trolleys could be controlled by the computer so that the rotation of these trolleys round the circular track would cause the balloon to change direction. These trolleys could be powered by electric motors. On the balloon could be mounted a set of propellers which are rotated by the wind. These propellers would be connected to turbines which generate electricity. The turbines could be attached on or under the balloon. The electricity thus generated could be transferred to ground level by electric conducting tethers that could be the same or different tethers from those used to control the height and direction of the balloon.

The control of the complete system, together with any additional modifications and additions, could be by a computer. In the event of any failure of the system, there could be a back-up computer on the ground. A modification and improvement to this could be that in the event that the main computer fails and that the back-up computer receives a “no-signal” input, it would automatically give the command to bring the gas balloon down to ground-level. Also in times of no wind or too much turbulence or very high speed wind the computer could cause the apparatus to return to the ground, by means of the winches.

The motors of the system could be powered by the electricity generated. Alternatively, there could be a stand-by system of batteries that in the event of an emergency, lowering the balloon would be powered by the batteries.

A further improvement could be to have additional propellers and turbines mounted on the tethers thus allowing even more electricity to be generated. This would transform the balloon to a vertical wind-farm.

A further modification could be to have antennas mounted on the balloon for the purposes of radio, cellular phone and the like, enabling quality reception and transmission. Since they would be mounted so high-up they would cover a vast reception and transmission area.

A further modification could be to have equipment, mounted at varying heights along the tethers and on the balloon itself, capable of transmitting to meteorological bureaus, the different data of the weather, including temperature, wind speed and direction, etc.

The meteorological data could also be transmitted to the computer of this device so that it could ensure that the balloon is always facing the prevailing winds or to bring the system to the ground in unfavorable conditions. A further improvement could be that the computer could give individual commands to the different winches on the trolleys, thus ensuring that the balloon can change its horizontal angle or tilt, thus ensuring that the leading edge of the propellers is always at the optimum angle vis-a-vis the direction of the wind.

The computer could turn the balloon round, so that the turbines on the balloon are constantly facing the prevailing winds, by instructing the trolleys to move accordingly.

### BRIEF DESCRIPTION OF THE DRAWINGS

The accompanying drawings, which are incorporated in and form a part of this specification, illustrate embodiments of the invention and, together with the description, serve to explain, by way of example only, the principles of the invention:

FIG. 1: is a schematic depiction of the airborne generator.

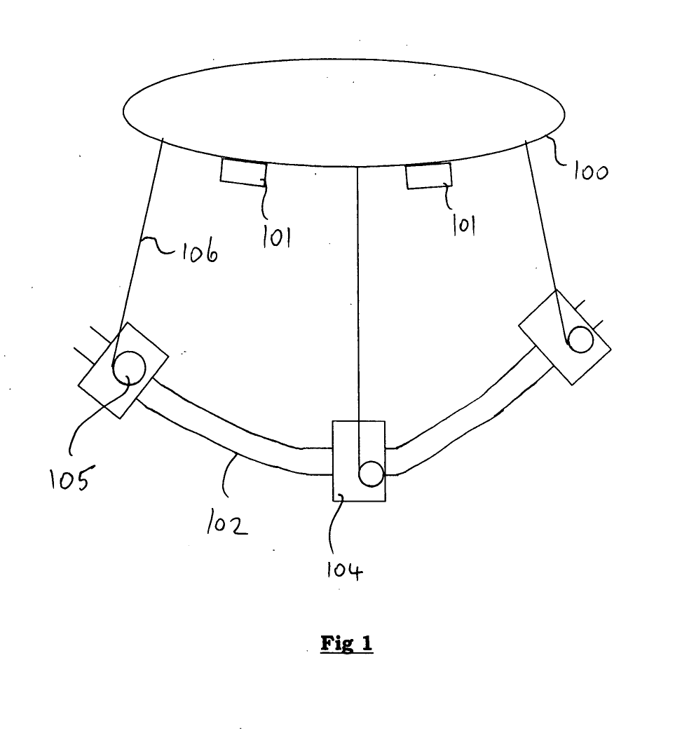

### DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

The invention comprises an aerodynamically designed gas filled balloon 100. On the edge of the balloon 100 are mounted wind-driven turbines 101. The gas-filled balloon 100 is moored to three mobile trolleys 104 via three tethers 106, one to each trolley. The trolleys 104 are mounted on a circular track 102. The trolleys 104 are capable of moving forward and backwards along the track 102, being powered by an electric motor. On the deck of each of the trolleys 104 is a motorized winch 105 to which the tethers 106 are attached. The winches and the trolleys are controlled by a computer.

The tethers 106 also transfer the electricity generated by the turbines 101 down to transformers at ground level. A computer at ground level controls the complete system. An improvement and modification to this invention could be a second computer to provide back-up facilities should, for any reason, the first computer fail.

An improvement to this system that in the event of a “no-signal” input, the computer could automatically lower the balloon 100 to the ground.

The computer could be capable of giving a command to each individual winch on the trolleys 104 to wind or unwind. This action would change the length of the tethers 106, thus tightening or slackening the tethers 106. Each tether 106 could be tightened individually, thus adjusting the horizontal angle or tilt of the balloon 100. This would allow that the edge of the propellers of the turbines 101 to be at the optimum angle to the wind.

The computer could be capable of giving commands to the individual trolleys 104 to move forward or backward round the circular track 102, thus ensuring that the balloon 100 is constantly facing the optimum direction. The computer could give commands also to lower the complete system in the event of any emergency.

A further improvement could be the mounting of additional turbines on the tethers 106.

An additional modification could be the mounting of antennas, for radio or cellular communications on the tethers 106 or on the balloon 100.

An additional modification could be to have cameras mounted on the said apparatus for various purposes for example supervisory needs of surrounding farmers, traffic surveillance for local police purposes or for general security purposes.

What is claimed: The present invention is not intended to be limited to the embodiments described above, but to encompass any and all embodiments within the scope of the following claims.

1. An airborne electricity generator comprising,
a) at least one wind propelled electricity producing turbine,
b) at least one gas filled balloon to support the airborne apparatus,
c) at least one trolley at ground level connected to the said airborne apparatus,
d) at least one circular track on which the said trolley travels,
e) at least one tether for each said trolley to hold the said airborne apparatus at an controlled height and for carrying electricity from the said generator to ground-level,
f) a means to control height, tilt and direction of the said balloon to catch the highest wind speed,
whereby electricity is produced in airborne turbines powered by the kinetic energy of wind and thereafter transferred to ground level.

2. An airborne electricity generator as claimed in claim 1 wherein the said trolley runs on a circular track whereby the said balloon and turbine can face the direction of the wind in the optimal way.

3. An airborne electricity generator as claimed in claim 1 wherein the said turbine is connected to propellers that are turned on their central axis by the force of moving wind.

4. An airborne electricity generator as claimed in claim 1 wherein the said tethers are at least three to control the height, tilt and direction of the said turbine.

5. An airborne electricity generator as claimed in claim 1 wherein the said tethers are electric cables.

6. An airborne electricity generator as claimed in claim 1 wherein the said tethers are a combination of metal and electrical cables.

7. An airborne electricity generator as claimed in claim 1 further comprising winches to wind up and let out the said tether thereby adjusting the height, direction and tilt of the said balloon and said turbine.

8. An airborne electricity generator as claimed in claim 1 further comprising a computer to input information including at least one of the following factors to calculate the optimum position of the said turbine to produce the optimum amount of electric energy, namely, the height, the wind speed, the wind direction, the turbulence of the wind and the current direction and tilt of the said apparatus.

9. An airborne electricity generator as claimed in claim 7 wherein the said computer has a software program to make the said calculations and according to the results of the said calculation output instruction to the said trolley and the said winches in such a way that the said apparatus will move to the optimum direction height and tilt.

10. An airborne electricity generator comprising,
a) at least one wind propelled electricity producing turbine,
b) at least one gas filled balloon to support the airborne apparatus,
c) at least one trolley at ground level connected to the said airborne apparatus,
d) an airborne framework onto which is connected the said apparatus,
e) at least one circular track on which the said trolley travels,
f) at least one tether for each said trolley to hold the said airborne apparatus at a controlled height and for carrying electricity from the said generator to ground-level,
g) at least one winch to which the said tether is attached,
h) a computer and program and means to control the height, tilt and direction of the said balloon and said turbine to catch the optimal wind speed,
whereby electricity is produced in airborne turbines powered by the kinetic energy of wind and thereafter transferred to ground level.

11. An airborne electricity generator as claimed in claim 10 wherein the said trolley runs on a circular track whereby the said balloon and turbine can face the direction of the wind in the optimal way.

12. An airborne electricity generator as claimed in claim 10 wherein the said turbine has fins that are turned on their central axis by the force of moving wind.

13. An airborne electricity generator as claimed in claim 10 wherein the said tethers are at least three to control the height and direction of the said turbine.

14. An airborne electricity generator as claimed in claim 10 wherein the said tethers are electric cables.

15. An airborne electricity generator as claimed in claim 10 wherein the said tethers are a combination of steel and electrical cables.

16. An airborne electricity generator comprising,
a) at least one wind propelled electricity producing turbine,
b) at least one gas filled balloon to support the airborne apparatus,
c) at least one tether for each said trolley to hold the said airborne apparatus at an controlled height and for carrying electricity from the said generator to ground-level,
d) a means to control height, tilt and direction of the said balloon to catch the highest wind speed, whereby electricity is produced in airborne turbines powered by the kinetic energy of wind and thereafter transferred to ground level.

17. An airborne electricity generator as claimed in claim 1 wherein the said turbine is connected to propellers that are turned on their central axis by the force of moving wind.

18. An airborne electricity generator as claimed in claim 1 wherein the said tethers are electric cables.

19. An airborne electricity generator as claimed in claim 1 further comprising a computer to input information including at least one of the following factors to calculate the optimum position of the said turbine to produce the optimum amount of electric energy, namely, the height, the wind speed, the wind direction, the turbulence of the wind and the current direction and tilt of the said apparatus.

20. An airborne electricity generator as claimed in claim 7 wherein the said computer has a software program to make the said calculations and according to the results of the said calculation output instruction to the said trolley and the said winches in such a way that the said apparatus will move to the optimum direction height and tilt.
